(19) United States
(12) Patent Application Publication
(10) Pub. No.: US 2026/0323218 A1
(43) Pub. Date: Oct. 15, 2026

(54) VIBRATION SOUND PRODUCTION APPARATUS AND ELECTRONIC DEVICE

(71) Applicant: Goertek Inc., Weifang (CN)

(72) Inventors: Gudong Zhao, Weifang (CN); Linlin Zhang, Weifang (CN); Jizong Wang, Weifang (CN)

(73) Assignee: Goertek Inc., Weifang (CN)

(21) Appl. No.: 19/477,858

(22) PCT Filed: Jan. 18, 2024
(86) PCT No.: PCT/CN2024/072989

§ 371 Date: Oct. 23, 2025

(30) Foreign Application Priority Data
Apr. 25, 2023 (CN) 202321002987.1
Sep. 8, 2023 (CN) 202322438653.5

(51) Int. Cl. H04R 9/02; H04R 1/02; H04R 7/04; H04R 9/04; H04R 9/06

(52) U.S. Cl. CPC H04R 9/025; H04R 1/025; H04R 7/04; H04R 9/045; H04R 9/046; H04R 9/06

(57) ABSTRACT

The disclosed subject matter provides a vibration sound production apparatus including a housing, a magnetic circuit system, and a first and a second vibration system. A central and a side magnetic part are spaced apart to form a magnetic gap. Magnetization directions of two adjacent first sub-central magnets are opposite. The first and the second vibration systems are respectively on opposite sides of the system. A voice coil of the first vibration system is inserted into the magnetic gap. The second vibration system includes an elastic connecting member and a vibrator assembly, with the former suspending the latter within an installation space. The vibrator assembly includes a driving coil having two connecting edges disposed oppositely each of the two connecting edges is disposed opposite to a respective one of two adjacent first sub-central magnets along a second direction.

### CROSS-REFERENCE TO RELATED APPLICATIONS

This application is a National Stage of International Application No. PCT/CN2024/072989 filed on Jan. 18, 2024, which claims priority to Chinese Patent Application No. 202321002987.1 filed on Apr. 25, 2023, and to Chinese Patent Application No. 202322438653.5 filed on Sep. 8, 2023, all of which are hereby incorporated by reference in their entireties.

### TECHNICAL FIELD

The present disclosure relates to the field of electro-acoustic equipment, and in particular, to a vibration sound production apparatus and an electronic device.

### BACKGROUND

Smart terminal devices, especially mobile phone products, usually need to possess both audio experience and vibration haptic feedback experience functions. Among them, the audio experience comes from a sound production unit, and the vibration haptic feedback experience comes from a vibration unit. In the related art, a vibration sound production module integrating a sound production unit and a vibration unit into one body has been proposed. In such a module, the sound production unit and the vibration unit are arranged separately to form independent control units, and the sound production unit and the vibration unit are stacked in a stacked configuration within a housing of the vibration sound production module. Although the above structure can achieve the integration of the sound production unit and the vibration unit, the aforementioned vibration sound production module occupies too much assembly space, thereby affecting the miniaturization and lightweight design of the terminal device.

The present disclosure aims to address at least one of the technical problems existing in the prior art. To this end, there is provided a vibration sound production apparatus. The vibration sound production apparatus having a simple and compact structure and exhibiting good sound production and vibration effects.

The present disclosure also proposes an electronic device having the aforementioned vibration sound production apparatus.

A vibration sound production apparatus according to an embodiment of a first aspect of the present disclosure includes: a housing, wherein an installation space is defined within the housing; a magnetic circuit system, the magnetic circuit system including a central magnetic part and a side magnetic part located outside the central magnetic part, the central magnetic part and the side magnetic part being arranged spaced apart to define a magnetic gap, the central magnetic part including a plurality of first sub-central magnets distributed spaced apart along a first direction, wherein magnetization directions of two adjacent first sub-central magnets are opposite; a first vibration system and a second vibration system, the first vibration system and the second vibration system being respectively arranged on opposite sides of the magnetic circuit system, the first vibration system vibrating along a second direction perpendicular to the first direction, the first vibration system including a diaphragm assembly and a voice coil, one end of the voice coil being connected to the diaphragm assembly, the other end of the voice coil being inserted into the magnetic gap; the second vibration system vibrating along the first direction, the second vibration system including an elastic connecting member and a vibrator assembly, two ends of the elastic connecting member being connected to the vibrator assembly and an inner wall of the housing respectively to suspend the vibrator assembly within the installation space, the vibrator assembly including a driving coil, the driving coil having two connecting edges arranged opposite to each other, wherein along the second direction, each of the two connecting edges is arranged opposite to a respective one of two adjacent first sub-central magnets.

In the vibration sound production apparatus according to the embodiment of the first aspect of the present disclosure, by arranging the central magnetic part to include a plurality of first sub-central magnets distributed spaced apart along the first direction, and by arranging, along the second direction, each of the two connecting edges of the driving coil to be arranged opposite to a respective one of two adjacent first sub-central magnets, the part of the magnetic field of the central magnetic part that has low utilization in the first vibration system can be used as the magnetic field for the second vibration system. This improves the magnetic field utilization rate of the central magnetic part, eliminates the need for a separate magnetic circuit system, and reduce production costs. In addition, it also saves the assembly space occupied by a separate magnetic circuit system, thereby enabling the miniaturization and thinning design of the vibration sound production apparatus.

According to some embodiments of the present disclosure, there are at least three of the first sub-central magnets, every two adjacent first sub-central magnets are arranged spaced apart to form a spacing portion, the number of the driving coils is equal to the number of the spacing portions, and the driving coils have their central holes arranged in a one-to-one correspondence with the spacing portions.

According to some embodiments of the present disclosure, the central magnetic part further includes a central magnetic conduction plate, and the plurality of first sub-central magnets have their sides facing away from the second vibration system all connected to the central magnetic conduction plate.

According to some embodiments of the present disclosure, the magnetic circuit system further includes a magnetic conduction yoke, the magnetic conduction yoke includes a body portion and a hollowed-out hole provided in the body portion, the side magnetic part and the first sub-central magnets located at both end positions are all provided on the body portion, and along the second direction, the hollowed-out hole and the driving coil are at least partially arranged opposite to each other.

According to some embodiments of the present disclosure, the central magnetic part further includes a central magnetic conduction plate, the plurality of first sub-central magnets have their sides facing away from the second vibration system all connected to the central magnetic conduction plate, the magnetic circuit system further includes a magnetic conduction yoke, the magnetic conduction yoke includes a body portion and a hollowed-out hole provided in the body portion, the central magnetic conduction plate includes a support portion and an extension portion provided outside the support portion, the extension portion extends along the second direction, two ends of the extension portion are connected to the support portion and the body portion respectively, the support portion is arranged opposite to the hollowed-out hole, and the plurality of first sub-central magnets are all fixed to the support portion.

In some embodiments of the present disclosure, along a third direction perpendicular to the first direction and the second direction respectively, the extension portion is located on opposite sides of the support portion, and the side magnetic part and the extension portion are arranged spaced apart to define a part of the magnetic gap.

According to some embodiments of the present disclosure, the side magnetic part includes a side magnet, the central magnetic part further includes second sub-central magnets provided on both sides of the plurality of first sub-central magnets in a third direction, the third direction is perpendicular to the first direction and the second direction respectively, the side magnet, the first sub-central magnets, and the second sub-central magnets are all magnetized along the second direction, along the first direction, magnetization directions between each adjacent pair of side magnet and first sub-central magnet, and between every two adjacent first sub-central magnets, are all opposite, and along the third direction, magnetization directions between each adjacent pair of side magnet and second sub-central magnet are all opposite.

In some embodiments of the present disclosure, the central magnetic part further includes a central magnetic conduction plate, the plurality of first sub-central magnets and the second sub-central magnets have their sides facing away from the second vibration system all connected to the central magnetic conduction plate, the magnetic circuit system further includes a magnetic conduction yoke, the magnetic conduction yoke includes a body portion and a hollowed-out hole provided in the body portion, the side magnet and the second sub-central magnets are all provided on the body portion, and along the second direction, the hollowed-out hole and the driving coil are at least partially arranged opposite to each other.

According to some embodiments of the present disclosure, along the first direction, a gap between every two adjacent first sub-central magnets is close to zero or equal to zero.

An electronic device according to an embodiment of a second aspect of the present disclosure further includes the vibration sound production apparatus as set forth in any of the preceding embodiments of the present disclosure.

In the electronic device according to the embodiment of the second aspect of the present disclosure, by arranging the aforementioned vibration sound production apparatus, the structural design of the vibration sound production apparatus is compact, occupies a small assembly space, and also has good sound production and vibration effects, thereby meeting the thinning design requirements of the electronic device. Moreover, it can also enable the electronic device to possess both good sound quality and vibration feedback effects, enhancing the product market competitiveness of the electronic device.

Additional aspects and advantages of the present disclosure will be given in part in the following description, will become apparent in part from the following description, or will be learned through the practice of the present disclosure.

### BRIEF DESCRIPTION OF THE DRAWINGS

The above and/or additional aspects and advantages of the present disclosure will become apparent and readily understood from the description of the embodiments in conjunction with the following drawings, in which:

FIG. 1 is an exploded structural schematic diagram of a vibration sound production apparatus according to an embodiment of the present disclosure;

FIG. 2 is an exploded structural schematic diagram of a vibration sound production apparatus according to another embodiment of the present disclosure;

FIG. 3 is a vertical cross-sectional view of a vibration sound production apparatus along a first direction according to an embodiment of the present disclosure;

FIG. 4 is a vertical cross-sectional view of a vibration sound production apparatus along a first direction according to another embodiment of the present disclosure;

FIG. 5 is a vertical cross-sectional view of a vibration sound production apparatus along a third direction according to an embodiment of the present disclosure;

FIG. 6 is a vertical cross-sectional view of a vibration sound production apparatus along a third direction according to another embodiment of the present disclosure;

FIG. 7 is a vertical cross-sectional view of a vibration sound production apparatus along a third direction according to yet another embodiment of the present disclosure.

### REFERENCE NUMERALS

Vibration sound production apparatus 100,
Housing 1,
Magnetic circuit system 2, Central magnetic part 21, First sub-central magnet 211, Second sub-central magnet 212, Central magnetic conduction plate 213, Support portion 2131, Extension portion 2132, Side magnetic part 22, Side magnet 221, Side magnetic conduction plate 222, First plate body 2221, Second plate body 2222, Recessed portion 222a, Magnetic gap 2a, Spacing portion 2b, Magnetic conduction yoke 23, Body portion 231, Hollowed-out hole 232,
First vibration system 3, Diaphragm assembly 31, Diaphragm 311, Dome 312, Voice coil 32, Second vibration system 4, Elastic connecting member 41, Vibrator assembly 42, Counterweight block 421, Mounting groove 421a, Driving coil 422, Connecting edge 4221.

### DETAILED DESCRIPTION

The embodiments of the present disclosure are described in detail below, examples of which are illustrated in the accompanying drawings, wherein the same or similar reference numerals throughout denote the same or similar components or components having the same or similar functions. The embodiments described below with reference to the accompanying drawings are exemplary and are intended to explain the present disclosure, but should not be construed as limiting the present disclosure.

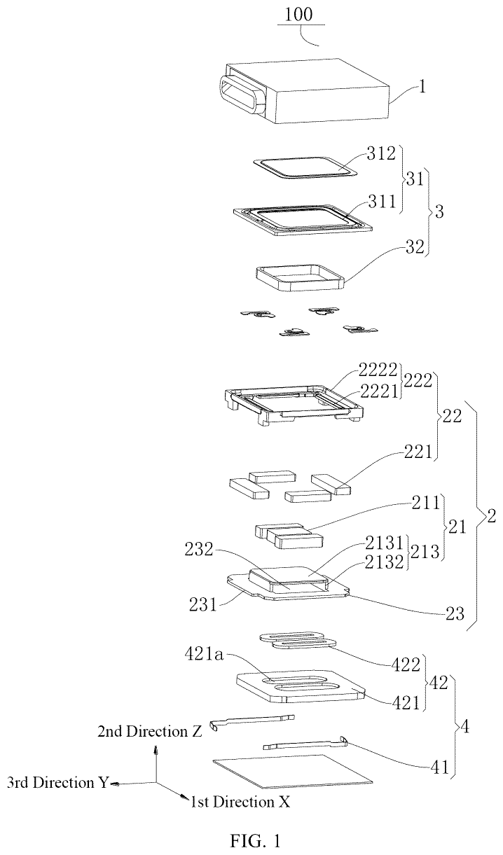

The vibration sound production apparatus 100 according to the embodiment of the first aspect of the present disclosure is described in detail below with reference to FIGS. 1 to 7. The vibration sound production apparatus 100 can be a speaker module having both sound production and vibration functions.

As shown in FIGS. 1 to 7, the vibration sound production apparatus 100 according to the embodiment of the first aspect of the present disclosure includes: a housing 1, a magnetic circuit system 2, a first vibration system 3, and a second vibration system 4.

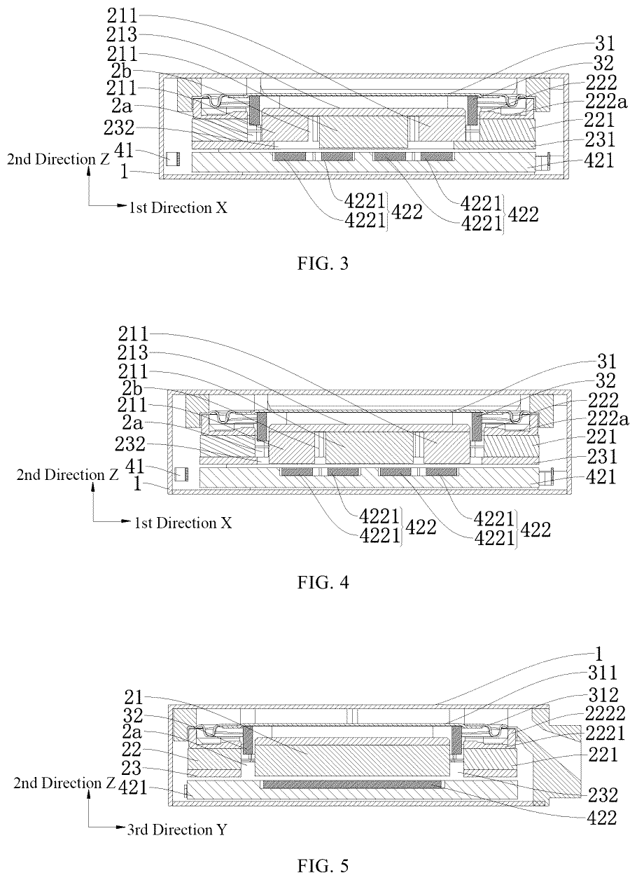

As shown in FIGS. 3 to 7, an installation space can be defined within the housing 1. The magnetic circuit system 2 is arranged within the installation space. The first vibration system 3 and the second vibration system 4 can be respectively arranged on opposite sides of the magnetic circuit system 2. Among them, the magnetic circuit system 2 can include a central magnetic part 21 and a side magnetic part 22 arranged outside the central magnetic part 21. The central magnetic part 21 and the side magnetic part 22 are arranged spaced apart to define a magnetic gap 2a. The central magnetic part 21 includes a plurality of first sub-central magnets 211 distributed spaced apart along a first direction. Magnetization directions of two adjacent first sub-central magnets 211 are opposite.

The first vibration system 3 can vibrate along a second direction perpendicular to the first direction. The first vibration system 3 can include a diaphragm assembly 31 and a voice coil 32. One end of the voice coil 32 is connected to the diaphragm assembly 31, and the other end of the voice coil 32 is inserted into the magnetic gap 2a. For example, the first direction can be a horizontal direction, and the second direction can be a vertical direction. That is, the voice coil 32 can reciprocate along the vertical direction driven by magnetic field force, thereby driving the diaphragm assembly 31 to vibrate and produce sound, realizing the sound production function of the vibration sound production apparatus 100. In a specific example of the present disclosure, the diaphragm assembly 31 can include a diaphragm 311 and a dome 312. The diaphragm 311 is connected to the housing 1 or the magnetic circuit system 2. The dome 312 is arranged on the diaphragm 311. The end of the voice coil 32 away from the magnetic circuit system 2 is connected to the dome 312.

As shown in FIGS. 3 to 4, the second vibration system 4 can vibrate along the first direction. The second vibration system 4 includes an elastic connecting member 41 and a vibrator assembly 42. Two ends of the elastic connecting member 41 are connected to the vibrator assembly 42 and an inner wall of the housing 1 respectively to suspend the vibrator assembly 42 within the installation space. The vibrator assembly 42 includes a counterweight block 421 and a driving coil 422 provided on the counterweight block 421. The driving coil 422 has two connecting edges 4221 arranged opposite to each other. Along the second direction, each of the two connecting edges 4221 is arranged opposite to a respective one of two adjacent first sub-central magnets 211.

Specifically, since the elastic connecting member 41 suspends the vibrator assembly 42 within the installation space, when the second vibration system 4 is working, a current is passed through the driving coil 422. Driven by the magnetic field force of the magnetic circuit system 2, the driving coil 422 can drive the counterweight block 421 to reciprocate together along the first direction, thereby generating a vibration sensation and realizing the vibration function of the vibration sound production apparatus 100. Optionally, there can be a plurality of driving coils 422. The plurality of driving coils 422 can be arranged distributed at intervals, and the connecting edges 4221 of each driving coil 422 are arranged parallel to each other.

It can be understood that the magnetic field utilization rate of the central magnetic circuit part of a typical speaker is relatively low. In the present disclosure, by arranging the central magnetic part 21 to include a plurality of first sub-central magnets 211 distributed spaced apart along the first direction, and by arranging, along the second direction, each of the two connecting edges 4221 of the driving coil 422 to be arranged opposite to a respective one of two adjacent first sub-central magnets 211, the part of the magnetic field of the central magnetic part 21 that has low utilization in the first vibration system 3 can be used as the magnetic field for the second vibration system 4. This can improve the magnetic field utilization rate of the central magnetic part 21, eliminates the need for a separate magnetic circuit system 2, and reduce production costs. In addition, it can also save the assembly space occupied by a separate magnetic circuit system 2, thereby meeting the miniaturization and thinning design of the vibration sound production apparatus 100. Through the above analysis, it can be seen that the first vibration system 3 and the second vibration system 4 in the present disclosure share one set of magnetic circuit system 2. Both the sound production function and the vibration function can be achieved through one set of magnetic circuit system 2. Moreover, the structure is simple and compact, meeting the requirements for miniaturization and lightweight.

According to the vibration sound production apparatus 100 of the embodiment of the first aspect of the present disclosure, by arranging the central magnetic part 21 to include a plurality of first sub-central magnets 211 distributed spaced apart along the first direction, and by arranging, along the second direction, each of the two connecting edges 4221 of the driving coil 422 to be arranged opposite to a respective one of two adjacent first sub-central magnets 211, the part of the magnetic field of the central magnetic part 21 that has low utilization in the first vibration system 3 can be used as the magnetic field for the second vibration system 4. This can improve the magnetic field utilization rate of the central magnetic part 21, eliminates the need for a separate magnetic circuit system 2, and reduce production costs. In addition, it can also save the assembly space occupied by a separate magnetic circuit system 2, thereby meeting the miniaturization and thinning design of the vibration sound production apparatus 100.

As shown in FIGS. 1 to 4, according to some embodiments of the present disclosure, there are at least three first sub-central magnets 211. Every two adjacent first sub-central magnets 211 are arranged spaced apart to form a spacing portion 2b. The number of the driving coils 422 is equal to the number of the spacing portions 2b, and the central holes of the driving coils 422 are arranged in a one-to-one correspondence with the spacing portions 2b. Specifically, the driving coil 422 can be formed in a flat shape. The two connecting edges 4221 of the driving coil 422 are provided on opposite sides of the central hole. Herein, the central hole of the driving coil 422 is directly opposite to the spacing portion 2b formed by two adjacent first sub-central magnets 211, and the two connecting edges 4221 are respectively arranged opposite to the two adjacent first sub-central magnets 211. Furthermore, the number of the driving coils 422 is equal to the number of the spacing portions 2b, which ensures that one driving coil 422 is provided between every two adjacent first sub-central magnets 211. Thus, through the above arrangement, each driving coil 422 corresponds to a pair of first sub-central magnets 211 arranged spaced apart, and the first connecting edge 4221 and the second connecting edge 4221 can fully cut the magnetic induction lines, thereby improving the vibration effect of the vibrator assembly 42.

It needs to be explained that the aforementioned “distributed spaced apart”/“arranged spaced apart” of the first sub-central magnets 211 can be understood as every two adjacent first sub-central magnets 211 are arranged as separate bodies. Along the first direction, the gap between every two adjacent first sub-central magnets 211 can be large or small, and can be selected and set according to actual usage requirements.

Optionally, along the first direction, a gap between every two adjacent first sub-central magnets 211 is close to zero or equal to zero, that is, the width of the spacing portion 2b is close to zero or equal to zero. That is to say, every two adjacent first sub-central magnets 211 can be arranged abutting each other. In the case where the gap between every two adjacent first sub-central magnets 211 is equal to zero, the spacing portion 2b between them can be the contact surface/point/line between the two adjacent first sub-central magnets 211. It can be understood that although every two adjacent first sub-central magnets 211 are arranged abutting each other, due to the existence of assembly errors and material errors, a tiny gap (spacing portion 2b) will exist between every two adjacent first sub-central magnets 211. In another specific example of the present disclosure, along the first direction, the width of the spacing portion 2b can be 0.05 mm±0.02 mm.

Arranging every two adjacent first sub-central magnets 211 abutting each other, compared to the situation where there is a relatively wide gap between every two adjacent first sub-central magnets 211, can increase the magnet size and volume, providing greater magnetic field strength.

Furthermore, since during typical magnet assembly, magnets with different magnetization directions are assembled separately, for example, in the case of three first sub-central magnets 211, the two first sub-central magnets 211 located at the end positions are fixed first, and then the first sub-central magnet 211 located at the middle position is inserted into the assembly space defined between the two first sub-central magnets 211 located at the end positions. Thus, in the case where adjacent first sub-central magnets 211 are arranged abutting each other, precise positioning of the first sub-central magnet 211 in the middle position is not required, simplifying the assembly process of the central magnetic part 21 and improving assembly efficiency. Moreover, since the three first sub-central magnets 211 are arranged abutting each other, during the assembly of the subsequently installed first sub-central magnet 211, the adhesive used for fixation will overflow to the peripheral sides of the magnets and then seep into the tiny gap between every two adjacent first sub-central magnets 211, which can adhesively bond the two adjacent first sub-central magnets 211 together. Thereby, the three first sub-central magnets 211 can form an integrally bonded whole, greatly enhancing the structural firmness of the central magnetic part 21. When the product is dropped or impacted, it is less likely for the first sub-central magnets 211 to become loose or fall off.

As shown in FIGS. 3 to 4, according to some embodiments of the present disclosure, the side magnetic part 22 can include a side magnet 221. The side magnet 221 and the plurality of first sub-central magnets 211 are all magnetized along the second direction, and the magnetization directions between the adjacent side magnet 221 and first sub-central magnet 211, and between every two adjacent first sub-central magnets 211, are all opposite. For example, the second direction can be the vertical direction, that is, the side magnet 221 and the plurality of first sub-central magnets 211 are all magnetized along the vertical direction; one of the adjacent side magnet 221 and first sub-central magnet 211 and one of every two adjacent first sub-central magnets 211 is magnetized in the direction from top to bottom, and the other of the adjacent side magnet 221 and first sub-central magnet 211 and the other of every two adjacent first sub-central magnets 211 is magnetized in the direction from bottom to top. Thus, through the above arrangement, the voice coil 32 can fully cut the magnetic induction lines within the magnetic gap 2a formed between the side magnetic part 22 and the central magnetic part 21, and the driving coil 422 can fully cut the magnetic induction lines within the spacing portion 2b formed between every two adjacent first sub-central magnets 211, which can ensure the sound production and vibration effects of the vibration sound production apparatus 100.

As shown in FIGS. 3 to 4, according to some embodiments of the present disclosure, the central magnetic part 21 further includes a central magnetic conduction plate 213. The plurality of first sub-central magnets 211 have their sides facing away from the second vibration system 4 all connected to the central magnetic conduction plate 213. The central magnetic conduction plate 213 can not only function to gather magnetic flux lines but also assemble the plurality of first sub-central magnets 211 together, facilitating the installation and fixation of the plurality of first sub-central magnets 211.

As shown in FIG. 3, according to some embodiments of the present disclosure, the magnetic circuit system 2 can further include a magnetic conduction yoke 23. The magnetic conduction yoke 23 includes a body portion 231 and a hollowed-out hole 232 provided in the body portion 231. The side magnetic part 22 and the first sub-central magnets 211 located at both end positions are all provided on the body portion 231. Along the second direction, the hollowed-out hole 232 and the driving coil 422 are at least partially arranged opposite to each other. Specifically, one end of the plurality of first sub-central magnets 211 can be connected to the central magnetic conduction plate 213, and the other end of the first sub-central magnets 211 located at the end positions is fixed to the body portion 231. Thereby, the magnetic conduction yoke 23 can not only fix the side magnetic part 22 and the central magnetic part 21 but also function to concentrate magnetic flux, ensuring the magnetic field strength corresponding to the first vibration system 3. By providing the hollowed-out hole 232 on the body portion 231, the hollowed-out hole 232 can be opposite to a part of the driving coil 422 or opposite to the entire driving coil 422, thereby ensuring that the driving coil 422 can effectively cut the magnetic flux lines, thus ensuring the vibration effect of the second vibration system 4.

Optionally, there can be a plurality of driving coils 422 and one hollowed-out hole 232. The hollowed-out hole 232 is arranged corresponding to the plurality of driving coils 422, which can simplify the machining process of the hollowed-out hole 232 and improve machining efficiency. Optionally, there can be a plurality of driving coils 422 and a plurality of hollowed-out holes 232 can be provided. The plurality of hollowed-out holes 232 are arranged in a one-to-one correspondence with the plurality of driving coils 422, which can relatively reduce the opening area of the magnetic conduction yoke 23, thereby not only improving the structural strength of the magnetic conduction yoke 23 but also enhancing its magnetic flux concentration effect.

As shown in FIG. 3, in some embodiments of the present disclosure, projections of the other first sub-central magnets 211 located between the first sub-central magnets 211 at the end positions along the second direction are all located inside the edge of the hollowed-out hole 232, thereby ensuring the number of magnetic flux lines passing through the hollowed-out hole 232 and thus ensuring the vibration effect of the second vibration system 4.

Furthermore, along the second direction, the other first sub-central magnets 211 located between the first sub-central magnets 211 at the end positions all extend into the hollowed-out hole 232, thereby reducing the distance between the central magnetic part 21 and the driving coil 422, thus increasing the strength of the magnetic flux lines acting on the driving coil 422, and consequently improving the vibration effect of the second vibration system 4.

Below, the vibration sound production apparatus 100 according to a specific embodiment of the present disclosure is described in detail with reference to FIG. 3 and FIG. 5.

As shown in FIG. 3 and FIG. 5, the vibration sound production apparatus 100 includes: a housing 1, a magnetic circuit system 2, a first vibration system 3, and a second vibration system 4.

The magnetic circuit system 2 is arranged within the installation space defined by the housing 1. The first vibration system 3 and the second vibration system 4 are respectively arranged on opposite sides of the magnetic circuit system 2. The magnetic circuit system 2 includes a magnetic conduction yoke 23, and a central magnetic part 21 and a side magnetic part 22 provided on the magnetic conduction yoke 23. The side magnetic part 22 is arranged outside the central magnetic part and the central magnetic part 21 and the side magnetic part 22 are arranged spaced apart to define a magnetic gap 2a. The central magnetic part 21 includes three first sub-central magnets 211 and a central magnetic conduction plate 213. The three first sub-central magnets 211 are distributed spaced apart along a first direction (the x-direction shown in FIGS. 1-7). The end of each first sub-central magnet 211 facing away from the second vibration system 4 is connected to the central magnetic conduction plate 213. Every two adjacent first sub-central magnets 211 are arranged spaced apart to form a spacing portion 2b. The side magnetic part 22 includes a side magnet 221 and a side magnetic conduction plate 222 provided on the side of the side magnet 221 facing away from the second vibration system 4. Herein, the side magnet 221 and the plurality of first sub-central magnets 211 are all magnetized along the second direction, and the magnetization directions between the adjacent side magnet 221 and first sub-central magnet 211 and between every two adjacent first sub-central magnets 211 are all opposite. The magnetic conduction yoke 23 includes a body portion 231 and a hollowed-out hole 232 provided in the body portion 231. The side magnet 221 and the first sub-central magnets 211 located at both end positions are all provided on the body portion 231. Along the second direction (the z-direction shown in FIGS. 1-7), the first sub-central magnet 211 located at the middle position extends into the hollowed-out hole 232.

The first vibration system 3 vibrates along the second direction. The first vibration system 3 includes a diaphragm assembly 31 and a voice coil 32. The diaphragm assembly 31 includes a diaphragm 311 and a dome 312 provided on the diaphragm 311. One end of the voice coil 32 is fixed to the dome 312, and the other end of the voice coil 32 is inserted into the magnetic gap 2a. The side magnetic conduction plate 222 includes a first plate body 2221 extending horizontally and a second plate body 2222 extending vertically. The first plate body 2221 is provided on the side of the side magnet 221 facing away from the second vibration system 4. One end of the second plate body 2222 is connected to the first plate body 2221, and the other end of the second plate body 2222 extends along the second direction. Both ends of the diaphragm 311 are fixed to the second plate body 2222. Herein, a corrugated surround of the diaphragm 311 extends along the second direction toward a direction close to the side magnetic part 22. The first plate body 2221 is provided with a recessed portion 222a arranged corresponding to the corrugated surround.

The second vibration system 4 vibrates along the first direction. The second vibration system 4 includes an elastic connecting member 41 and a vibrator assembly 42. Two ends of the elastic connecting member 41 are connected to the vibrator assembly 42 and an inner wall of the housing 1 respectively to suspend the vibrator assembly 42 within the installation space. The vibrator assembly 42 includes a counterweight block 421 and two driving coils 422 provided on the counterweight block 421. Each driving coil 422 has two connecting edges 4221 arranged opposite to each other. Along the second direction, each of the two connecting edges 4221 is arranged opposite to a respective one of two adjacent first sub-central magnets 211.

Specifically, when the vibration sound production apparatus 100 is working, after a current is passed through the voice coil 32, it moves to cut the magnetic flux lines within the magnetic gap 2a, thereby driving the diaphragm assembly 31 to vibrate and produce sound. After a current is passed through the driving coil 422, it moves to cut the magnetic flux lines within the spacing portion 2b, thereby driving the vibrator assembly 42 to reciprocate, thus functioning to generate a vibration sensation.

As shown in FIG. 1 and FIG. 7, according to some embodiments of the present disclosure, the central magnetic part 21 can further include a central magnetic conduction plate 213. The plurality of first sub-central magnets 211 have their sides facing away from the second vibration system 4 all connected to the central magnetic conduction plate 213. The magnetic circuit system 2 further includes a magnetic conduction yoke 23. The magnetic conduction yoke 23 includes a body portion 231 and a hollowed-out hole 232 provided in the body portion 231. The central magnetic conduction plate 213 can include a support portion 2131 and an extension portion 2132 provided outside the support portion 2131. The extension portion 2132 extends along the second direction. Two ends of the extension portion 2132 are connected to the support portion 2131 and the body portion 231 respectively. The support portion 2131 is arranged opposite to the hollowed-out hole 232. The plurality of first sub-central magnets 211 are all fixed to the support portion 2131.

Specifically, the central magnetic conduction plate 213 can not only function to gather magnetic flux lines but also assemble the plurality of first sub-central magnets 211 together. The central magnetic conduction plate 213 includes a support portion 2131 extending along the first direction and an extension portion 2132 extending along the second direction. One end of the plurality of first sub-central magnets 211 can be connected to the support portion 2131. The two ends of the extension portion 2132 are connected to the support portion 2131 and the body portion 231 respectively. Thereby, the magnetic conduction yoke 23 can support the central magnetic part 21 through the extension portion 2132. The hollowed-out hole 232 is provided on the body portion 231 of the magnetic conduction yoke 23. The other end of the plurality of first sub-central magnets 211 can be opposite to the hollowed-out hole 232. The hollowed-out hole 232 can be opposite to a part of the driving coil 422 or opposite to the entire driving coil 422, thereby ensuring that the driving coil 422 can effectively cut the magnetic flux lines, thus ensuring the vibration effect of the second vibration system 4.

As shown in FIG. 1 and FIG. 7, in some embodiments of the present disclosure, along a third direction perpendicular to the first direction and the second direction respectively, the extension portion 2132 is located on opposite sides of the support portion 2131. The side magnetic part 22 and the extension portion 2132 are arranged spaced apart to define a part of the magnetic gap 2a. Specifically, the first direction and the third direction can be located in the same horizontal plane. For example, the first direction can be the horizontal x-direction, the third direction can be the horizontal y-direction, and the second direction can be the vertical z-direction. Herein, there can be two extension portions 2132. The two extension portions 2132 can be provided on both sides of the support portion 2131 in the third direction, thereby connecting the support portion 2131 and the magnetic conduction yoke 23 together, making the structural design relatively simple. Herein, the side magnetic part 22 and the extension portion 2132 are arranged spaced apart to define one part of the magnetic gap 2a, and the side magnetic part 22 can also be arranged spaced apart from the first sub-central magnets 211 located at the end positions and the central magnetic conduction plate 213 to define another part of the magnetic gap 2a.

In some embodiments of the present disclosure, projections of the plurality of first sub-central magnets 211 along the second direction are all located inside the edge of the hollowed-out hole 232, thereby ensuring the number of magnetic flux lines passing through the hollowed-out hole 232 and thus ensuring the vibration effect of the second vibration system 4.

Furthermore, along the second direction, the plurality of first sub-central magnets 211 all extend into the hollowed-out hole 232, thereby reducing the distance between the central magnetic part 21 and the driving coil 422, thus increasing the strength of the magnetic flux lines acting on the driving coil 422, and consequently improving the vibration effect of the second vibration system 4.

Below, the vibration sound production apparatus 100 according to a specific embodiment of the present disclosure is described in detail with reference to FIG. 1, FIG. 4, and FIG. 7.

As shown in FIG. 1, FIG. 4, and FIG. 7, the vibration sound production apparatus 100 includes: a housing 1, a magnetic circuit system 2, a first vibration system 3, and a second vibration system 4.

The magnetic circuit system 2 is arranged within the installation space defined by the housing 1. The first vibration system 3 and the second vibration system 4 are respectively arranged on opposite sides of the magnetic circuit system 2. The magnetic circuit system 2 includes a magnetic conduction yoke 23, and a central magnetic part 21 and a side magnetic part 22 provided on the magnetic conduction yoke 23. The side magnetic part 22 is arranged outside the central magnetic part and the central magnetic part 21 and the side magnetic part 22 are arranged spaced apart to define a magnetic gap 2a.

The central magnetic part 21 includes three first sub-central magnets 211 and a central magnetic conduction plate 213. The central magnetic conduction plate 213 includes a support portion 2131 extending along a first direction (the x-direction shown in FIGS. 1-7) and an extension portion 2132 extending along a second direction (the z-direction shown in FIGS. 1-7). The two ends of the extension portion 2132 are connected to the support portion 2131 and the body portion 231 respectively. There are two extension portions 2132, and they are provided at both ends of the support portion 2131 in a third direction (the y-direction shown in FIGS. 1-7). The three first sub-central magnets 211 are distributed spaced apart along the first direction. The end of each first sub-central magnet 211 facing away from the second vibration system 4 is connected to the support portion 2131. Every two adjacent first sub-central magnets 211 are arranged spaced apart to form a spacing portion 2b. The side magnetic part 22 includes a side magnet 221 and a side magnetic conduction plate 222 provided on the side of the side magnet 221 facing away from the second vibration system 4. The side magnet 221 and the plurality of first sub-central magnets 211 are all magnetized along the second direction, and the magnetization directions between the adjacent side magnet 221 and first sub-central magnet 211 and between every two adjacent first sub-central magnets 211 are all opposite. The magnetic conduction yoke 23 includes a body portion 231 and a hollowed-out hole 232 provided in the body portion 231. The side magnet 221 is provided on the body portion 231. The two ends of the extension portion 2132 are connected to the support portion 2131 and the body portion 231 respectively. Along the second direction, the plurality of first sub-central magnets 211 are opposite to the hollowed-out hole 232.

The first vibration system 3 vibrates along the second direction. The first vibration system 3 includes a diaphragm assembly 31 and a voice coil 32. The diaphragm assembly 31 includes a diaphragm 311 and a dome 312 provided on the diaphragm 311. One end of the voice coil 32 is fixed to the dome 312, and the other end of the voice coil 32 is inserted into the magnetic gap 2a. The side magnetic conduction plate 222 includes a first plate body 2221 extending horizontally and a second plate body 2222 extending vertically. The first plate body 2221 is provided on the side of the side magnet 221 facing away from the second vibration system 4. One end of the second plate body 2222 is connected to the first plate body 2221, and the other end of the second plate body 2222 extends along the second direction. Both ends of the diaphragm 311 are fixed to the second plate body 2222. Herein, a corrugated surround of the diaphragm 311 extends along the second direction toward a direction close to the side magnetic part 22. The first plate body 2221 is provided with a recessed portion 222a arranged corresponding to the corrugated surround.

The second vibration system 4 vibrates along the first direction. The second vibration system 4 includes an elastic connecting member 41 and a vibrator assembly 42. Two ends of the elastic connecting member 41 are connected to the vibrator assembly 42 and an inner wall of the housing 1 respectively to suspend the vibrator assembly 42 within the installation space. The vibrator assembly 42 includes a counterweight block 421 and two driving coils 422 provided on the counterweight block 421. The two driving coils 422 are distributed spaced apart along the first direction. Each driving coil 422 has two connecting edges 4221 arranged opposite to each other. Along the second direction, each of the two connecting edges 4221 is arranged opposite to a respective one of two adjacent first sub-central magnets 211.

Specifically, when the vibration sound production apparatus 100 is working, after a current is passed through the voice coil 32, it moves to cut the magnetic flux lines within the magnetic gap 2a, thereby driving the diaphragm assembly 31 to vibrate and produce sound. After a current is passed through the driving coil 422, it moves to cut the magnetic flux lines within the spacing portion 2b, thereby driving the vibrator assembly 42 to reciprocate, thus functioning to generate a vibration sensation.

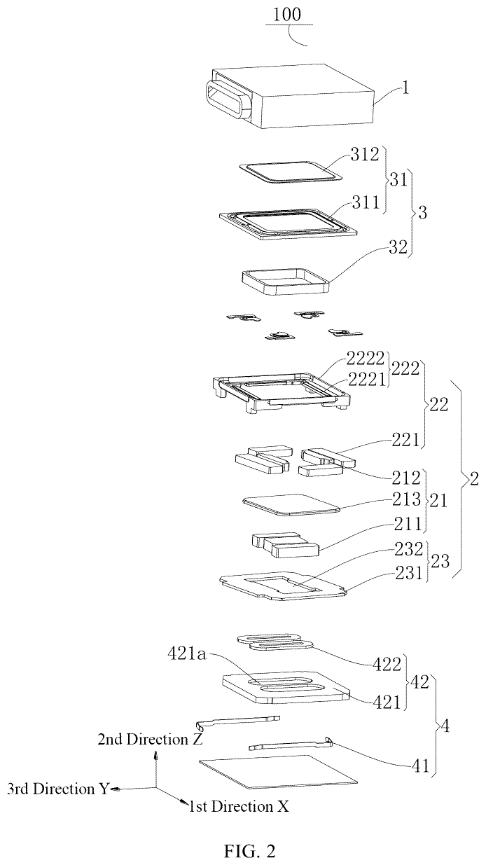

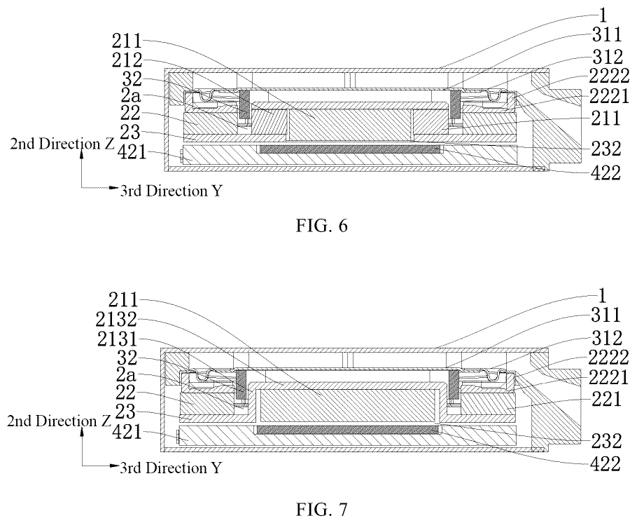

As shown in FIG. 2 and FIG. 6, according to some embodiments of the present disclosure, the side magnetic part 22 can include a side magnet 221. The central magnetic part 21 further includes second sub-central magnets 212 provided on both sides of the plurality of first sub-central magnets 211 in a third direction. The third direction is perpendicular to the first direction and the second direction respectively. The side magnet 221, the first sub-central magnets 211, and the second sub-central magnets 212 are all magnetized along the second direction. Along the first direction, magnetization directions between each adjacent pair of side magnet and first sub-central magnet, and between every two adjacent first sub-central magnets, are all opposite. Along the third direction, magnetization directions between each adjacent pair of side magnet and second sub-central magnet are all opposite.

Specifically, the first direction and the third direction can be located in the same horizontal plane. For example, the first direction can be the horizontal x-direction, the third direction can be the horizontal y-direction, and the second direction can be the vertical z-direction. Herein, the central magnetic part 21 includes a plurality of first sub-central magnets 211 arranged spaced apart along the first direction and second sub-central magnets 212 arranged spaced apart along the second direction. Herein, the side magnet 221, the first sub-central magnets 211, and the second sub-central magnets 212 are all magnetized along the second direction. For example, the second direction can be the vertical z-direction. Along the first direction, one of the adjacent side magnet and first sub-central magnet and one of every two adjacent first sub-central magnets is magnetized in the direction from top to bottom, and the other of the adjacent side magnet and first sub-central magnet and the other of every two adjacent first sub-central magnets is magnetized in the direction from bottom to top. Along the third direction, one of the adjacent side magnet and second sub-central magnet is magnetized in the direction from top to bottom, and the other of the adjacent side magnet and second sub-central magnet is magnetized in the direction from bottom to top.

Thus, through the above arrangement, the voice coil 32 can fully cut the magnetic flux lines within the magnetic gap 2a formed between the side magnetic part 22 and the central magnetic part 21, and the driving coil 422 can fully cut the magnetic flux lines within the spacing portion 2b formed between every two adjacent first sub-central magnets 211, which can ensure the sound production and vibration effects of the vibration sound production apparatus 100.

As shown in FIG. 6, in some embodiments of the present disclosure, the central magnetic part 21 further includes a central magnetic conduction plate 213. The plurality of first sub-central magnets 211 and the second sub-central magnets 212 have their sides facing away from the second vibration system 4 all connected to the central magnetic conduction plate 213. The magnetic circuit system 2 further includes a magnetic conduction yoke 23. The magnetic conduction yoke 23 includes a body portion 231 and a hollowed-out hole 232 provided in the body portion 231. The side magnet 221 and the second sub-central magnets 212 are all provided on the body portion 231. Along the second direction, the hollowed-out hole 232 and the driving coil 422 are at least partially arranged opposite to each other.

Specifically, the central magnetic conduction plate 213 can not only function to gather magnetic flux lines but also assemble the plurality of first sub-central magnets 211 and the second sub-central magnets 212 together. Herein, the side magnet 221 and the second sub-central magnets 212 can all be fixed to the body portion 231 of the magnetic conduction yoke 23. Thereby, the magnetic conduction yoke 23 can support the central magnetic part 21 and the side magnetic part 22, and can also function to concentrate magnetic flux, ensuring the magnetic field strength corresponding to the first vibration system 3. The hollowed-out hole 232 is provided on the body portion 231 of the magnetic conduction yoke 23. The hollowed-out hole 232 can be opposite to a part of the driving coil 422 or opposite to the entire driving coil 422, thereby ensuring that the driving coil 422 can effectively cut the magnetic flux lines, thus ensuring the vibration effect of the second vibration system 4.

In some embodiments of the present disclosure, projections of the plurality of first sub-central magnets 211 along the second direction can all be located inside the edge of the hollowed-out hole 232, thereby ensuring the number of magnetic flux lines passing through the hollowed-out hole 232 and thus ensuring the vibration effect of the second vibration system 4.

Furthermore, along the second direction, the plurality of first sub-central magnets 211 all extend into the hollowed-out hole 232, thereby reducing the distance between the central magnetic part 21 and the driving coil 422, thus increasing the strength of the magnetic flux lines acting on the driving coil 422, and consequently improving the vibration effect of the second vibration system 4.

Furthermore, there can be a plurality of driving coils 422 and one hollowed-out hole 232. The hollowed-out hole 232 is arranged corresponding to the plurality of driving coils 422, which can simplify the machining process of the hollowed-out hole 232 and improve machining efficiency. Certainly, there can be a plurality of driving coils 422 and a plurality of hollowed-out holes 232 can be provided. The plurality of hollowed-out holes 232 are arranged in a one-to-one correspondence with the plurality of driving coils 422, which can relatively reduce the opening area of the magnetic conduction yoke 23, thereby improving the magnetic flux concentration effect and the structural strength of the magnetic conduction yoke 23.

Below, the vibration sound production apparatus 100 according to a specific embodiment of the present disclosure is described in detail with reference to FIG. 2, FIG. 4, and FIG. 6.

As shown in FIG. 2, FIG. 4, and FIG. 6, the vibration sound production apparatus 100 includes: a housing 1, a magnetic circuit system 2, a first vibration system 3, and a second vibration system 4.

The magnetic circuit system 2 is arranged within the installation space defined by the housing 1. The first vibration system 3 and the second vibration system 4 are respectively arranged on opposite sides of the magnetic circuit system 2. The magnetic circuit system 2 includes a magnetic conduction yoke 23, and a central magnetic part 21 and a side magnetic part 22 provided on the magnetic conduction yoke 23. The side magnetic part 22 is arranged outside the central magnetic path and the central magnetic part 21 and the side magnetic part 22 are arranged spaced apart to define a magnetic gap 2a.

The central magnetic part 21 includes three first sub-central magnets 211, two second sub-central magnets 212, and a central magnetic conduction plate 213. The three first sub-central magnets 211 are distributed spaced apart along a first direction (the x-direction shown in FIGS. 1-7). The two second sub-central magnets 212 are provided on both sides of the three first sub-central magnets 211 in a third direction (the y-direction shown in FIGS. 1-7). The end of each first sub-central magnet 211 and each second sub-central magnet 212 facing away from the second vibration system 4 is connected to the support portion 2131. Every two adjacent first sub-central magnets 211 are arranged spaced apart to form a spacing portion 2b. The side magnetic part 22 includes a side magnet 221 and a side magnetic conduction plate 222 provided on the side of the side magnet 221 facing away from the second vibration system 4. The magnetic conduction yoke 23 includes a body portion 231 and a hollowed-out hole 232 provided in the body portion 231. The side magnet 221 and the second sub-central magnets 212 are all provided on the body portion 231. Along the second direction (the z-direction shown in FIGS. 1-7), the plurality of first sub-central magnets 211 are opposite to the hollowed-out hole 232. Herein, the side magnet 221, the first sub-central magnets 211, and the second sub-central magnets 212 are all magnetized along the second direction. Along the first direction, magnetization directions between each adjacent pair of side magnet and first sub-central magnet, and between every two adjacent first sub-central magnets, are all opposite. Along the third direction, magnetization directions between each adjacent pair of side magnet and second sub-central magnet are all opposite.

Herein, every two adjacent first sub-central magnets 211, and every adjacent first sub-central magnet 211 and second sub-central magnet 212, are arranged abutting each other. It can be understood that although every two adjacent first sub-central magnets 211, and every adjacent first sub-central magnet 211 and second sub-central magnet 212, are arranged abutting each other, due to the existence of assembly errors and material errors, a tiny gap will exist between every two adjacent first sub-central magnets 211, and between every adjacent first sub-central magnet 211 and second sub-central magnet 212. For example, along the second direction, the gap width between every two adjacent first sub-central magnets 211 can be 0.05 mm±0.02 mm; along the third direction, the gap width between every adjacent first sub-central magnet 211 and second sub-central magnet 212 can be 0.05 mm±0.02 mm.

Specifically, when the central magnetic part 21 is being assembled, the two first sub-central magnets 211 located at both ends in the second direction and the two second sub-central magnets 212 located at both ends in the third direction can be fixed first, and then the first sub-central magnet 211 located at the middle position is inserted into the assembly space defined collectively by the two first sub-central magnets 211 and the two second sub-central magnets 212. Thus, in the case where every adjacent first sub-central magnet 211 and every adjacent first sub-central magnet 211 and second sub-central magnet 212 are all arranged abutting each other, precise positioning of the first sub-central magnet 211 in the middle position is not required, simplifying the assembly process of the central magnetic part 21 and improving assembly efficiency. Moreover, since the five magnets are all arranged abutting each other in pairs, during the assembly of the subsequently installed first sub-central magnet 211, the adhesive used for fixation will overflow to the peripheral sides of the magnets and then seep into the tiny gap between every two adjacent first sub-central magnets 211 and between every adjacent first sub-central magnet 211 and second sub-central magnet 212, which can adhesively bond every two adjacent first sub-central magnets 211 and every adjacent first sub-central magnet 211 and second sub-central magnet 212 together. Thereby, the three first sub-central magnets 211 and the two second sub-central magnets 212 can form an integrally bonded whole, greatly enhancing the structural firmness of the central magnetic part 21. When the product is dropped or impacted, it is less likely for the first sub-central magnets 211 and the second sub-central magnets 212 to become loose or fall off.

The first vibration system 3 vibrates along the second direction. The first vibration system 3 includes a diaphragm assembly 31 and a voice coil 32. The diaphragm assembly 31 includes a diaphragm 311 and a dome 312 provided on the diaphragm 311. One end of the voice coil 32 is fixed to the dome 312, and the other end of the voice coil 32 is inserted into the magnetic gap 2a. The side magnetic conduction plate 222 includes a first plate body 2221 extending horizontally and a second plate body 2222 extending vertically. The first plate body 2221 is provided on the side of the side magnet 221 facing away from the second vibration system 4. One end of the second plate body 2222 is connected to the first plate body 2221, and the other end of the second plate body 2222 extends along the second direction. Both ends of the diaphragm 311 are fixed to the second plate body 2222. Herein, a corrugated surround of the diaphragm 311 extends along the second direction toward a direction close to the side magnetic part 22. The first plate body 2221 is provided with a recessed portion 222a arranged corresponding to the corrugated surround.

The second vibration system 4 vibrates along the first direction. The second vibration system 4 includes an elastic connecting member 41 and a vibrator assembly 42. Two ends of the elastic connecting member 41 are connected to the vibrator assembly 42 and an inner wall of the housing 1 respectively to suspend the vibrator assembly 42 within the installation space. The vibrator assembly 42 includes a counterweight block 421 and two driving coils 422 provided on the counterweight block 421. The two driving coils 422 are distributed spaced apart along the first direction. Each driving coil 422 has two connecting edges 4221 arranged opposite to each other. Along the second direction, each of the two connecting edges 4221 is arranged opposite to a respective one of two adjacent first sub-central magnets 211.

Specifically, when the vibration sound production apparatus 100 is working, after a current is passed through the voice coil 32, it moves to cut the magnetic flux lines within the magnetic gap 2a, thereby driving the diaphragm assembly 31 to vibrate and produce sound. After a current is passed through the driving coil 422, it moves to cut the magnetic flux lines within the spacing portion 2b, thereby driving the vibrator assembly 42 to reciprocate, thus functioning to generate a vibration sensation.

As shown in FIGS. 1 to 2, according to some embodiments of the present disclosure, a side of the counterweight block 421 close to the magnetic circuit system 2 is provided with a mounting groove 421a. The driving coil 422 is embedded in the mounting groove 421a, thereby making the structure of the vibrator assembly 42 more compact. Optionally, a fixing adhesive can be provided within the mounting groove 421a, and the driving coil 422 can be fixed within the mounting groove 421a by the fixing adhesive. It needs to be explained that the structural design of the counterweight block 421 is not limited to this. For example, the counterweight block 421 may also not be provided with the mounting groove 421a, and the driving coil 422 can be adhesively bonded to the outer surface of the counterweight block 421.

An electronic device according to an embodiment of a second aspect of the present disclosure includes the vibration sound production apparatus 100 according to the above-described embodiments of the present disclosure. Optionally, the electronic device can be a mobile phone, a PAD, a laptop computer, or the like.

In the electronic device according to the embodiment of the second aspect of the present disclosure, by arranging the aforementioned vibration sound production apparatus 100, the structural design of the vibration sound production apparatus 100 is compact, occupies a small assembly space, and also has good sound production and vibration effects, thereby meeting the thinning design requirements of the electronic device. Moreover, it can also enable the electronic device to possess both good sound quality and vibration feedback effects, enhancing the product market competitiveness of the electronic device.

In the description of the present disclosure, it is to be understood that terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, and the like, indicate orientations or positional relationships based on those shown in the drawings. They are used only for the convenience of describing the present disclosure and simplifying the description, rather than indicating or implying that the referred apparatus or component must have a specific orientation or be constructed and operated in a specific orientation. Therefore, they should not be construed as limiting the present disclosure. Furthermore, features defined with “first” and “second” may explicitly or implicitly include one or more of such features. In the description of the present disclosure, unless otherwise specified, “a plurality of” means two or more.

In the description of the present disclosure, it should be noted that, unless otherwise explicitly specified and defined, the terms “mount”, “connect”, and “link” are to be understood broadly. For example, it may be a fixed connection, a detachable connection, or an integral connection; it may be a mechanical connection, an electrical connection, or both; it may be a direct connection, an indirect connection through an intermediary, or an internal connection between two components. Those of ordinary skill in the art can understand the specific meanings of these terms in the present disclosure based on the specific circumstances.

In the description of this specification, references to the description of terms such as “one embodiment”, “some embodiments”, “an exemplary embodiment”, “example”, “a specific example”, or “some examples” mean that specific features, structures, materials, or characteristics described in connection with the embodiment or example are included in at least one embodiment or example of the present disclosure. In this specification, schematic representations of the above terms do not necessarily refer to the same embodiment or example. Furthermore, the described specific features, structures, materials, or characteristics may be combined in any suitable manner in one or more embodiments or examples.

Although embodiments of the present disclosure have been shown and described, those of ordinary skill in the art can understand that various changes, modifications, substitutions, and alterations can be made to these embodiments without departing from the principles and spirit of the present disclosure. The scope of the present disclosure is defined by the appended claims and their equivalents.

1. A vibration sound production apparatus, characterize comprising:
a housing, having an installation space therein;
a magnetic circuit system comprising a central magnetic part and a side magnetic part located outside the central magnetic part, the central magnetic part and the side magnetic part being spaced apart to form a magnetic gap, the central magnetic part comprising a plurality of first sub-central magnets, each having a magnetization direction, and distributed spaced apart along a first direction, wherein the magnetization directions of at least two of the plurality of first sub-central magnets that are adjacent are of opposite polarity; and
a first vibration system and a second vibration system, the first vibration system and the second vibration system being respectively disposed on opposite sides of the magnetic circuit system, the first vibration system vibrating along a second direction perpendicular to the first direction, the first vibration system comprising a diaphragm assembly and a voice coil, a first end of the voice coil being connected to the diaphragm assembly, a second end of the voice coil being inserted into the magnetic gap, the second vibration system configured to vibrating along the first direction, the second vibration system comprising an elastic connecting member and a vibrator assembly, wherein two ends of the elastic connecting member are connected to the vibrator assembly and an inner wall of the housing respectively to so that suspend the vibrator assembly is suspended within the installation space, the vibrator assembly comprises a driving coil having two connecting edges disposed opposite to each other, and each of the two connecting edges are disposed opposite to a respective one of the two adjacent first sub-central magnets along the second direction.

2. The vibration sound production apparatus according to claim 1, wherein, there are at least three of the first sub-central magnets, every two adjacent first sub-central magnets are disposed spaced apart to form a spacing portion, the number of the driving coils is equal to the number of the spacing portions, and the driving coils have their central holes disposed in a one-to-one correspondence with the spacing portions.

3. The vibration sound production apparatus according to claim 1, wherein, the central magnetic part further comprises a central magnetic conduction plate, and the plurality of first sub-central magnets have sides thereof facing away from the second vibration system connected to the central magnetic conduction plate.

4. The vibration sound production apparatus according to claim 1, wherein, the magnetic circuit system further comprises a magnetic conduction yoke, the magnetic conduction yoke comprises a body portion and a hollowed-out hole provided in the body portion, the side magnetic part and the first sub-central magnets located at both end positions are provided on the body portion, and the hollowed-out hole and the driving coil are at least partially disposed opposite to each other along the second direction.

5. The vibration sound production apparatus according to claim 1, wherein, the central magnetic part further comprises a central magnetic conduction plate, the plurality of first sub-central magnets have sides thereof facing away from the second vibration system connected to the central magnetic conduction plate, the magnetic circuit system further comprises a magnetic conduction yoke, the magnetic conduction yoke comprises a body portion and a hollowed-out hole provided in the body portion, the central magnetic conduction plate comprises a support portion and an extension portion provided outside the support portion, the extension portion extends along the second direction, two ends of the extension portion are connected to the support portion and the body portion respectively, the support portion is disposed opposite to the hollowed-out hole, and the plurality of first sub-central magnets are fixed to the support portion.

6. The vibration sound production apparatus according to claim 5, wherein, the extension portion is located on opposite sides of the support portion along a third direction perpendicular to the first direction and the second direction respectively, and the side magnetic part and the extension portion are disposed spaced apart to define form a part of the magnetic gap.

7. The vibration sound production apparatus according to claim 1, wherein, the side magnetic part comprises a side magnet, the central magnetic part further comprises second sub-central magnets provided on both sides of the plurality of first sub-central magnets along a third direction, the third direction is perpendicular to the first direction and the second direction respectively; the side magnet, the first sub-central magnets, and the second sub-central magnets are magnetized along the second direction; along the first direction, magnetization directions between each adjacent pair of the side magnet and first sub-central magnet are opposite to magnetization directions between every two adjacent first sub-central magnets; and along the third direction, magnetization directions between each adjacent pair of the side magnet and second sub-central magnet are opposite.

8. The vibration sound production apparatus according to claim 7, wherein, the central magnetic part further comprises a central magnetic conduction plate, the plurality of first sub-central magnets and the second sub-central magnets have sides thereof facing away from the second vibration system all connected to the central magnetic conduction plate; the magnetic circuit system further comprises a magnetic conduction yoke, the magnetic conduction yoke comprises a body portion and a hollowed-out hole provided in the body portion, the side magnet and the second sub-central magnets are all provided on the body portion; and along the second direction, the hollowed-out hole and the driving coil are at least partially disposed opposite to each other.

9. The vibration sound production apparatus according to claim 1, wherein a gap between every two adjacent first sub-central magnets is close to zero or equal to zero along the first direction.

10. An electronic device, comprising the vibration sound production apparatus according to claim 1.
